(19) United States
(12) Patent Application Publication
(10) Pub. No.: US 2010/0081503 A1
(43) Pub. Date: Apr. 1, 2010

(54) VIDEO GAME SYSTEM

(76) Inventor: Adam Johnson, Monroeville, PA (US)

Correspondence Address: JAY M. SCHLOFF, 6960 Orchard Lake Road, Suite 315, West Bloomfield, MI, 48322, US

(21) Appl. No.: 12/241,686

(22) Filed: Sep. 30, 2008

(51) Int. Cl. A63F 9/24; A63F 13/00

(52) U.S. Cl. 463/31; 463/47

(57) ABSTRACT

Disclosed is a video game system. The video game system includes a video game console, and a Compact Disc (CD) changing apparatus. The CD changing apparatus is connected to the video game console. Further, the CD changing apparatus is capable of accommodating, and reading a plurality of game CDs. Furthermore, the video game apparatus is capable of operating the CD changing apparatus to search and read a game CD from the plurality of game CDs for facilitating a user to play the video game stored on the game CD.

### FIELD OF THE INVENTION

The present invention relates to electronic accessories, and, more particularly to a video game accessory for storing multiple video game Compact Discs (CD) therein for playing games, by the help of a video game console connected thereto.

### BACKGROUND OF THE INVENTION

Video game consoles are used for playing games. Generally, a video game console receives a Compact Disc (CD) containing a game that is read by hardware and software installed therein, and provides an output to a user for playing the game stored in the game CD. Repeatedly playing the same game stored in the CD, the user may get bored. Accordingly, the user needs to change the CD by a new game CD, for playing a new game stored therein. Repetitive manual changing of game CDs for playing different games may cause wear and tear of the game CDs. Further, such repetitive manual changing of the game CDs may also cause inconvenience to the user, as the user has to move every time to change the game CDs for playing different games.

Accordingly, there exists a need of a video game apparatus that may be capable of facilitating a user to play different games, without repetitive manual changing of the game CDs to avoid movement of the user, every time the game CD needs to be changed. Further, there exists a need of a video game apparatus that may be capable of reducing wear and tear of game CDs caused by repetitive manual changing the game CDs.

### SUMMARY OF THE INVENTION

In view of the foregoing disadvantages inherent in the prior art, the general purpose of the present invention is to provide an arrangement and more specifically, a video game system that is configured to include all advantages of the prior art, and to overcome the drawbacks inherent therein.

It is accordingly an object of the present invention to provide a video game system that is capable of facilitating a user to play different games, by automatically selecting a game CD from a plurality of game CDs, thereby avoiding movement of the user, every time the game CD needs to be changed.

Another object of the present invention is to provide a CD changing apparatus that is capable of accommodating a plurality of game CDs that enables an automatic selection of a game CD from the plurality of game CDs, thereby avoiding a repetitive manual changing of the game CD to reduce wear and tear of the game CD.

To achieve the above objects, in an aspect of the present invention, a video game system is provided. The video game system includes a video game console and a Compact Disc (CD) changing apparatus. The CD changing apparatus is capable of accommodating, and reading a plurality of game CDs. Further, the CD changing apparatus is connected to the video game console. The video game console is capable of operating the CD changing apparatus to search and read a game CD from the plurality of game CDs.

Further, in another aspect of the present invention, a Compact Disc (CD) changing apparatus for a video game console is provided. The CD changing apparatus includes a housing, a reading mechanism and a movable mechanism. The housing is capable of accommodating a plurality of game CDs therein. The reading mechanism is disposed within the housing. The reading mechanism is capable of reading the plurality of game CDs. Further, the movable mechanism is configured within the housing for moving the plurality of game CDs. More particularly, the movable mechanism moves the plurality of game CDs for positioning a game CD from the plurality of game CDs, over the reading mechanism for enabling the reading mechanism to read the game CD.

These together with the other aspects of the present invention, along with the various features of novelty that characterized the present invention, are pointed out with particularity in the claims annexed hereto and form a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates a perspective view of a video game system, according to an exemplary embodiment of the present invention; and

FIG. 2 illustrated a perspective view of a Compact Disc (CD) changing apparatus, according to an exemplary embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “top”, “bottom”, “side”, and the like, herein do not denote any order, elevation or importance, but rather are used to distinguish placement of one element over another, and the terms “a” and “an” herein do not denote a limitation of quantity, but rather denote the presence of at least one of the referenced item.

The present invention provides a video game system for playing video games. As per a user's requirement, without moving from his/her position, the user enables the video game system to select a game Compact Disc (CD) from a plurality of game CDs. The user, based on his/her selection may, play a video game stored on the selected game CD. Furthermore, the present invention provides a CD changing apparatus for automatic selection of the game CD from the plurality of game CDs to play the video game stored thereon.

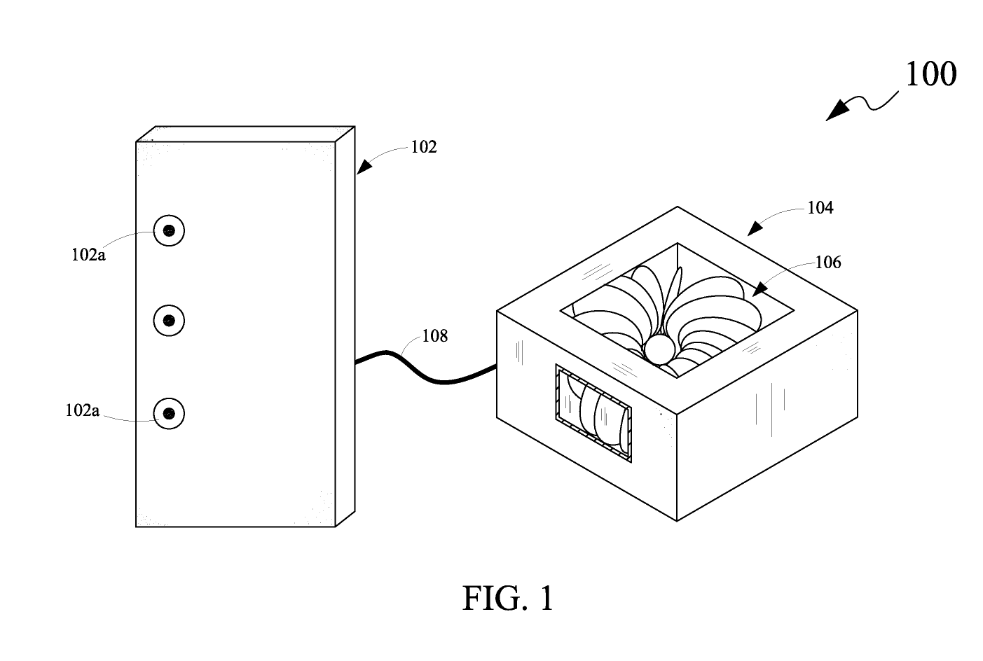

Referring now to FIG. 1, a video game system 100, according to an exemplary embodiment of the present invention is shown. The video game system 100 includes a video game console 102 and a Compact Disc changing apparatus 104 (hereinafter referred to as ‘CD changing apparatus’). The CD changing apparatus 104 is capable of accommodating and reading a plurality of game Compact Discs 106 (hereinafter referred to as ‘plurality of game CDs’) therein. The term ‘game CD’ used herein may also include a game Digital Versatile Disc (DVD) and a game carriage. Further, the CD changing apparatus 104 is connected to the video game console 102 for being operated in conjunction with each other. More particularly, the video game console 102 operates the CD changing apparatus 104 to search and read a game CD from the plurality of game CDs 106. The searching and reading of the game CD by the CD changing apparatus 104 allows a user to play the video game stored on the game CD by operating the video game console 102.

The video game console 102 is an interactive entertainment computer or electronic device. The video game console 102 is capable of producing a signal by pressing input buttons 102a disposed on the video game console 102. The signal may be a video display signal that may be used with a display device (not shown), such as a television and a monitor, for playing the video game. In one embodiment of the present invention, the video game console 102 may be connected to the CD changing apparatus 104 by a Universal Serial Bus (USB) cable 108. The USB cable 108 is capable of transferring a data from the video game console 102 to the CD changing apparatus 104, and vice versa. Further, in another embodiment of the present invention, the video game console 102 and the CD changing apparatus 104 may be wirelessly connected. The wireless connection therebetween may be established by interface devices, such as a Bluetooth device (not shown). The Bluetooth device is wireless protocol facilitating a data transfer from the video game console 102 to the CD changing apparatus 104, and vice versa.

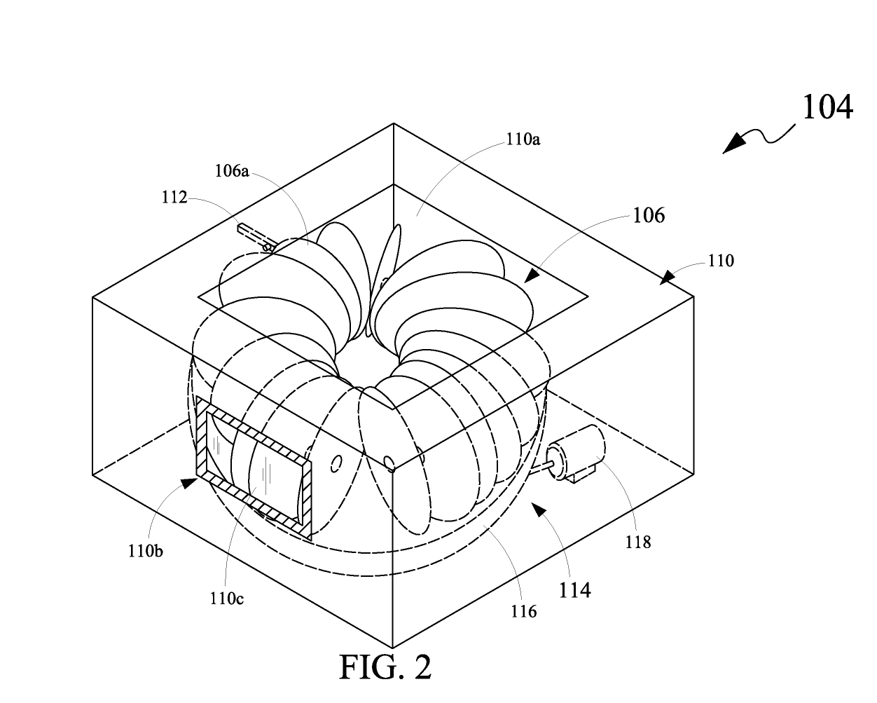

Referring now to FIG. 2, the CD changing apparatus 104, according to an exemplary embodiment of the present invention is shown and described in conjunction with FIG. 1. The CD changing apparatus 104 includes a housing 110, a reading mechanism 112, and a movable mechanism 114. The housing 110 is capable of accommodating the plurality of game CDs 106 therein. Further, the reading mechanism 112 is disposed within the housing 110 for reading a selected game CD, such as a game CD 106a from the plurality of game CDs 106. The movable mechanism 114 is configured within the housing 110, for moving the plurality of game CDs 106 and positioning the game CD 106a over the reading mechanism 112, for enabling the reading mechanism 112 to read the game CD 106a.

In an embodiment, the housing 110 is a rectangular enclosure capable of vertically accommodating the plurality of game CDs 106 therein. The rectangular enclosure includes a closable top opening 110a that may be opened for inserting the plurality of game CDs 106 therein. Further, the rectangular enclosure may also include a side opening 110b covered by a transparent material 110c. The transparent material 110c over the side opening 110b facilitates the user to view the plurality of game CDs 106 therefrom. More particularly, the plurality of game CDs 106 is accommodated vertically on the movable mechanism 114 within the housing 110, and rotates thereon.

The movable mechanism 114 includes a movable surface 116 and a motor 118. The movable surface 116 is capable of accommodating the plurality of game CDs 106 thereon. In one embodiment, the movable surface 116 is circular in shape and is rotatably configured within the housing 110. The movable surface 116 may be coupled from a center portion thereof, to a portion of the housing 110. Further, the motor 118 is disposed within the housing 110, and coupled to the movable surface 116 to rotate the movable surface 116 around a central axis of the movable surface 116. The movable surface 116 may be rotated by the motor 118, when the motor 118 receives an input signal from the video game console 102 through the USB cable 108. The input signal may be generated by pressing the input buttons 102a of the video game console 102.

The video game may be played by the user, upon selecting the game CD 106a from the plurality of game CDs 106. The user may operate the video game console 102 for selecting the game CD 106a from the plurality of game CDs 106 to play the video game. More particularly, the user may operate the video game console 102 to generate the input signal. The input signal is received by an application module (not shown) of the CD changing apparatus 104 through the USB cable 108. The application module process the input signal to operate the motor 118 for rotating the movable surface 116. Based on the selection of the user, the movable surface 116 rotates for positioning the selected game CD 106a over the reading mechanism 112. Accordingly, the reading mechanism 112 reads the selected game CD 106a from the plurality of game CDs 106, and provides an output signal. Further, the output signal is processed by the application module, and transferred to the video game console 102 by the USB cable 108. This arrangement facilitates in selecting a game CD from the plurality of game CDs 106, as per the user's requirement, for playing different video games without a need of manually changing game CDs.

The video game system 100 of the present invention is advantageous in facilitating a selection of a game CD from the plurality of game CDs as per the user's requirement, for playing different video games without a need of repetitive manual changing of the game CDs to avoid movement of the user, every time the game CD needs to be changed. Further, the CD changing apparatus 104 of the video game system 100 is capable of accommodating plurality of game CDs that enables an automatic selection of the game CD from the plurality of game CDs to reduce wear and tear of the plurality of game CDs.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omissions and substitutions of equivalents are contemplated as circumstances may suggest or render expedient, but such are intended to cover the application or implementation without departing from the spirit or scope of the claims of the present invention.

What is claimed is:

1. A video game system comprising:
a video game console; and
a Compact Disc (CD) changing apparatus capable of accommodating and reading a plurality of game CDs, the CD changing apparatus connected to the video game console,
wherein the video game console is capable of operating the CD changing apparatus to search and read a game CD from the plurality of game CDs.

2. The video game system of claim 1, wherein the video game console and the CD changing apparatus are connected by a Universal Serial Bus.

3. The video game system of claim 1, wherein the video game console and the CD changing apparatus are wirelessly connected.

4. The video game system of claim 1, wherein the CD changing apparatus comprises:
a housing for accommodating a plurality of game CDs;
a reading mechanism disposed within the housing, the reading mechanism capable of reading the plurality of game CDs; and
a movable mechanism configured within the housing, the movable mechanism capable of moving the plurality of game CDs and positioning a game CD from the plurality of game CDs over the reading mechanism for enabling the reading mechanism to read the game CD.

5. The CD changing apparatus of claim 4, wherein the housing is capable of accommodating the plurality of game CDs vertically with respect to the housing.

6. A Compact Disc (CD) changing apparatus for a video game console, the CD changing apparatus comprising:
a housing for accommodating a plurality of game CDs;
a reading mechanism disposed within the housing, the reading mechanism capable of reading the plurality of game CDs; and
a movable mechanism configured within the housing, the movable mechanism capable of moving the plurality of game CDs and positioning a game CD from the plurality of game CDs over the reading mechanism for enabling the reading mechanism to read the game CD.

7. The CD changing apparatus of claim 6, wherein the housing is capable of accommodating the plurality of game CDs vertically with respect to the housing.

8. The CD changing apparatus of claim 6, wherein the movable mechanism comprises:
a movable surface disposed within the housing; and
a motor disposed within the housing for rotating the movable surface.
